(19) United States
(12) Patent Application Publication
(10) Pub. No.: US 2009/0250462 A1
(43) Pub. Date: Oct. 8, 2009

(54) CHILDPROOF CONTAINER LID

(76) Inventor: Shlomo HAIMI, Or Akiva (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/409,578

(22) Filed: Mar. 24, 2009

Related U.S. Application Data
(63) Continuation-in-part of application No. 10/865,859, filed on Jun. 14, 2004, now Pat. No. 7,527,179.

(51) Int. Cl. B65D 41/02; B23P 19/04

(52) U.S. Cl. 220/260; 29/700

(57) ABSTRACT

The present invention is a childproof container lid having a lid removal arrangement configured to selectively limit rotation of an outer lid portion in relation to a seat portion configured to attach the lid to a container. The lid removal arrangement is engaged by displacing the outer lid portion in a direction longitudinally away from the container so as to engage complementary teeth configured in both the outer lid portion and the seat portion. Some embodiments may also include the step of inwardly squeezing an outer skirt in order to engage the teeth.

This application is a Continuation-In-Part of U.S. patent application Ser. No. 10/865,859 filed 14 Jun. 2004.

### FIELD AND BACKGROUND OF THE INVENTION

The present invention relates to container lids and, in particular, it concerns a childproof arrangement for container lid that requires a minimum of strength to operate.

It is known to provide childproof container lids. Generally, childproof lids fall into two types.

The first type requires sustained forceful longitudinal displacement of an outer portion of the lid toward the container while simultaneously turning the lid. The second type requires sustained inward radial displacement of a particular portion of an outer rim of the lid while turning the lid. These actions may be too difficult for some users.

There is therefore a need for a childproof container lid assembly that requires a minimum of strength to operate.

### SUMMARY OF THE INVENTION

The present invention is a childproof arrangement for container lid that requires a minimum of strength to operate.

1. A lid assembly for use with a container the lid assembly have a, the lid assembly comprising: (a) a seat portion for connection to the container; (b) an outer lid portion that encases at least a portion of the seat portion and turns freely bout the seat portion; and (c) a lid removal arrangement configured to selectively limit rotation of the outer lid portion in relation to the seat portion; wherein the lid removal arrangement is engaged by displacing the outer lid portion in a direction longitudinally away from the container.

According to a further teaching of the present invention, the removal arrangement includes complementary teeth configured in both the outer lid portion and the seat portion that are engaged one with another by the displacing the outer lid portion in a direction longitudinally away from the container.

There is also provided according to the teachings of the present invention, a method for removing a lid assembly from a container, the method comprising: (a) providing a seat portion for connection to the container; (b) providing an outer lid portion that encases at least a portion of the seat portion and turns freely about the seat portion; (c) providing a lid removal arrangement configured to selectively limit rotation of the outer lid portion in relation to the seat portion; (d) displacing the outer lid portion in a direction longitudinally away from the container so as to engage the lid removal arrangement; and (e) turning the lid assembly in a removal direction of rotation until the lid assembly is freed from the container.

According to a further teaching of the present invention, there is also provided complementary teeth configured in both the outer lid portion and the seat portion such that the displacing the outer lid portion in a direction longitudinally away from the container causes engagement of at least some of the teeth configured in the outer lid portion with at least some of the teeth configured in the seat portion.

### BRIEF DESCRIPTION OF THE DRAWINGS

The invention is herein described, by way of example only, with reference to the accompanying drawings, wherein:

FIG. 1 is a side cross section of a first preferred embodiment of a lid constructed and operative according to the teachings of the present invention, shown mounted on a container,

FIG. 2 is a side cross section of the embodiment of FIG. 1, showing the piston is a raised position;

FIG. 2A is a cross section taken along line A-A of FIG. 2;

FIG. 3 is a side cross section of a second preferred embodiment of a lid constructed and operative according to the teachings of the present invention, shown mounted on a container

FIG. 3A is a is a cross section taken along line B-B of FIG. 3; and

FIG. 4 is a detail of FIG. 3.

### DESCRIPTION OF THE PREFERRED EMBODIMENTS

The present invention is a childproof arrangement for container lid that requires a minimum of strength to operate.

The principles and operation of a childproof container lid according to the present invention may be better understood with reference to the drawings and the accompanying description.

By way of introduction, the present invention is a childproof container lid having a lid removal arrangement configured to selectively limit rotation of an outer lid portion in relation to a seat portion configured to attach the lid to a container. The lid removal arrangement is engaged by displacing the outer lid portion in a direction longitudinally away from the container so as to engage complementary teeth configured in both the outer lid portion and the seat portion. Some embodiments may also include the step of inwardly squeezing an outer skirt in order to engage the teeth.

The lid removal arrangement may be used in conjunction with a lid that includes an integral pump. Therefore, in some preferred embodiments of the present invention, the seat portion includes a pump cylinder and the rotatable outer portion includes a pump piston.

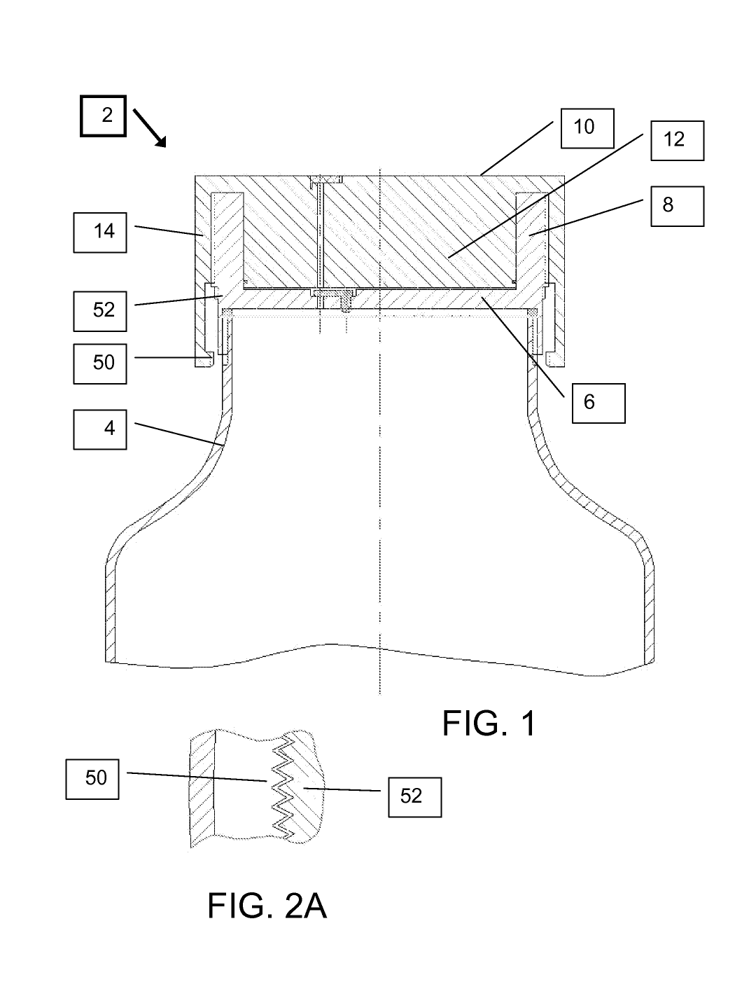

Referring now to the drawings, FIG. 1 illustrates a first preferred embodiment of a container lid of the present invention, generally referred to as 2, that is attached to a container 4. The seat portion 6 of the pump lid 2 may be attached to the container 4 in substantially any fashion known in the art. The seat portion is configured so as to include a substantially cylindrical pump cylinder 8. The rotatable piston portion 10 includes the pump piston 12 and the piston actuating element section 14, which are interconnected. In the preferred embodiments illustrated herein, the interconnection is by way of integral formation as a single molded piece. The pump piston 12 is deployed within the pump cylinder, while the piston actuating element section 14, configured as an outer skirt, extends beyond the wall of the pump cylinder so as to substantially circumscribe at least a portion of the pump cylinder and seat portion. Therefore, the piston actuating element section 14 is rotated about the pump cylinder.

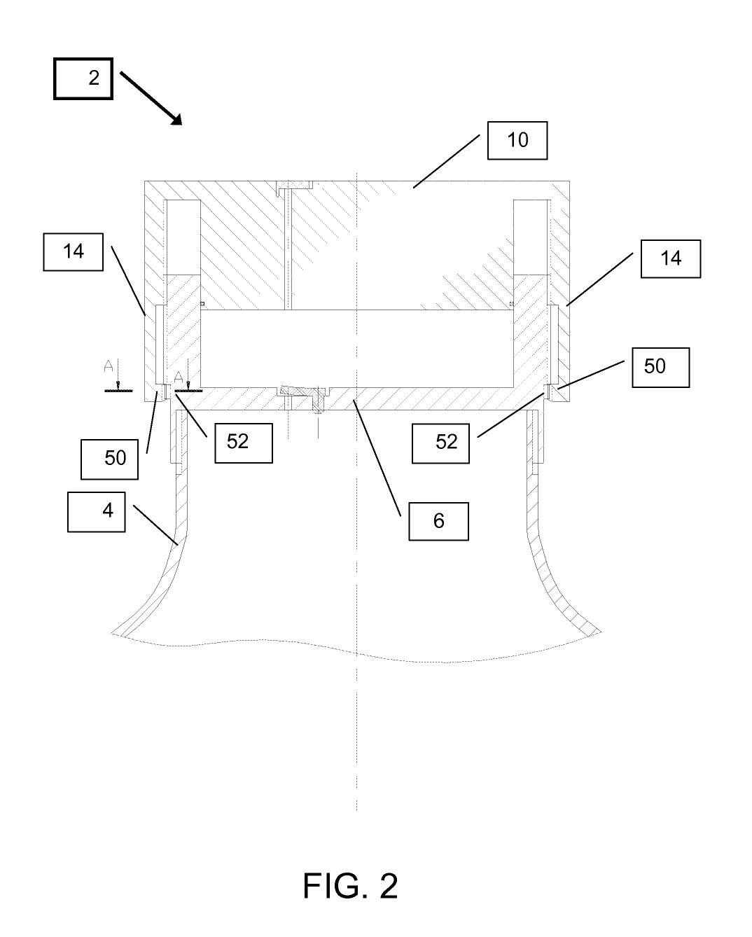

As illustrated in FIGS. 2 and 2A, in order to attach or remove the lid 2 for the container 4, the rotatable piston portion 10 of the lid is rotated to a fully extended position as illustrated in FIGS. 2. Once so extended, the teeth 50 configured so as to circumscribe the interior surface of the lower region of the piston actuating element section 14 engage the corresponding teeth 52 circumscribing the outer surface of the seat portion 6. Inward pressure applied to the lower area of the piston actuating element section 14 adjacent to the teeth 50 locks the teeth 50 with teeth 52, thereby allowing rotation of the seat portion 6 by rotating the rotatable piston portion 10 of the lid. It will be appreciated that the distance separating teeth 50 from teeth 52 may be such that no interlocking occurs until pressure is applied to the lower area of the piston actuating element section 14, thereby providing a childproof feature.

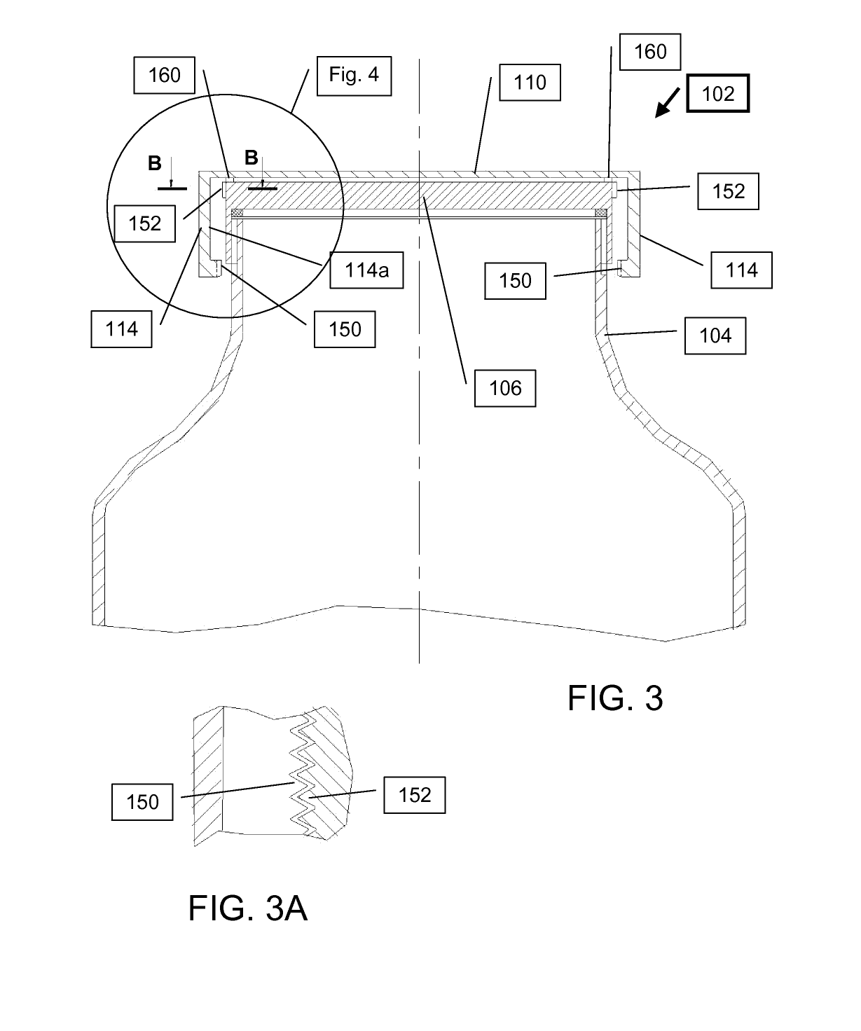

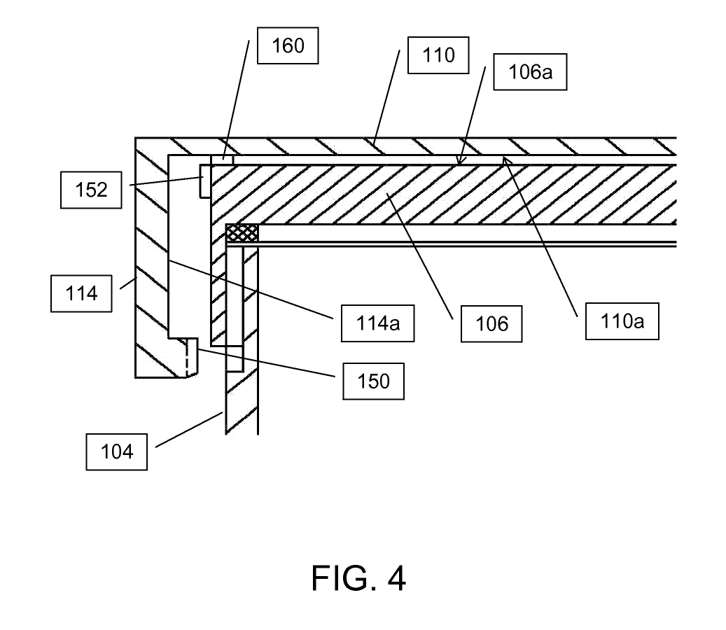

FIGS. 3-4 illustrate a second preferred embodiment of a container lid of the present invention, generally referred to as 102, that is attached to a container 104. This embodiment of the present invention does not include the pump mechanism of the embodiment of FIGS. 1 and 2 and is suitable for general use.

Lid 102 includes a seat portion 106 which may be attached to the container 104 in substantially any fashion known in the art. The outer lid portion 110 encases the seat portion 106 and turns freely about the seat portion 106 while the seat portion 106 remains stationary on the container 104.

The outer lid portion 110 includes an outer skirt 114 that extends longitudinally toward the container 104 so as to circumscribe the seat portion 106. Similar to the first preferred embodiment of FIG. 1, in order to effect rotational movement of the seat portion 106 and thereby enable removal of the lid 102 from the container 104, the outer lid portion is longitudinally displaced in a direction substantially away from the container until teeth 150 and 152 configured on the inner surface of the outer skirt 114 and the outer surface of the seat portion 106, respectively, become engaged. Once the teeth are engaged one with another, the lid 102 in turned in a removal direction of rotation.

That is to say, in order to remove the lid 102 from the container 104, the user simply lift the outer lid portion 110 in a direction away from the container until teeth 150 and 152 become engaged. Once teeth 150 and 152 are engaged, the entire lid 102 will rotate. The user then rotates lid 102 in a removal direction, generally counterclockwise, until the lid 102 is free from the container. Optionally and or additionally, the user may be required to inwardly radially displace (squeeze) at least a portion of the outer skirt 114 in order to engage at least some of teeth 150 with some of teeth 152.

It will be appreciated that the size and shape of teeth 150 and 152 is a matter of design choice and the teeth may be configured in substantially any suitable shape such as, but not limited to, triangular (as illustrated herein), square and trapezoidal. Further, the teeth need not be equal in size or spaced equally one from another.

It will be further appreciated that in substantially any embodiment of the present invention, teeth 150 may be configured at substantially any point longitudinally along the inner surface (here 114a) of the outer skirt 114. Likewise, teeth 152 may be configured at substantially any point longitudinally along the outer surface of the seat portion 106 so as to correspond to the position of teeth 150.

Deployment of lid 102 on the container may be achieved by aligning teeth 150 and 152 as described above and turning the lid in an attachment direction of rotation.

Alternatively, as illustrated in FIG. 4, the top surface 106a of the seat portion 106 and the interior surface 110a of the outer lid portion 110 may be configured with corresponding teeth 160 the are engaged by applying pressure on the outer lid portion 110 in a direction toward the seat portion 106. Preferably, but not necessarily, teeth 160 are configured to allow turning of the seat portion in an attachment direction only.

It will be appreciated that the above descriptions are intended only to serve as examples and that many other embodiments are possible within the spirit and the scope of the present invention.

What is claimed is:

1. A lid assembly for use with a container the lid assembly have a, the lid assembly comprising:
(a) a seat portion for connection to the container;
(b) an outer lid portion that encases at least a portion of said seat portion and turns freely bout said seat portion; and
(c) a lid removal arrangement configured to selectively limit rotation of said outer lid portion in relation to said seat portion;
wherein said lid removal arrangement is engaged by displacing said outer lid portion in a direction longitudinally away from the container.

2. The lid assembly of claim 1, wherein said removal arrangement includes complementary teeth configured in both said outer lid portion and said seat portion that are engaged one with another by said displacing said outer lid portion in a direction longitudinally away from the container.

3. A method for removing a lid assembly from a container, the method comprising:
(a) providing a seat portion for connection to the container;
(b) providing an outer lid portion that encases at least a portion of said seat portion and turns freely about said seat portion;
(c) providing a lid removal arrangement configured to selectively limit rotation of said outer lid portion in relation to said seat portion;
(d) displacing said outer lid portion in a direction longitudinally away from the container so as to engage said lid removal arrangement; and
(e) turning the lid assembly in a removal direction of rotation until the lid assembly is freed from the container.

4. The method of claim 3, further providing complementary teeth configured in both said outer lid portion and said seat portion such that said displacing said outer lid portion in a direction longitudinally away from the container causes engagement of at least some of said teeth configured in said outer lid portion with at least some of said teeth configured in said seat portion.
